(19) United States
(12) Patent Application Publication
(10) Pub. No.: US 2025/0019203 A1
(43) Pub. Date: Jan. 16, 2025

(54) DUST MITIGATION FOR OPTICAL POSITION REFERENCE SYSTEM OF AN ELEVATOR SYSTEM

(71) Applicant: Otis Elevator Company, Farmington, CT (US)

(72) Inventors: Brad Guilani, Woodstock Valley, CT (US); David R. Torlai, Torrington, CT (US)

(21) Appl. No.: 18/351,054

(22) Filed: Jul. 12, 2023

(51) Int. Cl. B66B 1/34; B66B 3/02; B66B 5/00

(52) U.S. Cl. CPC B66B 1/3492; B66B 3/023; B66B 5/0087

(57) ABSTRACT

A position reference system of an elevator system includes a reference element having a fixed position in a hoistway of the elevator system, and an optical sensor configured to move along the hoistway with an elevator car of the elevator system and configured to transmit a signal to the reference element to determine the position of the elevator car. An airflow duct is configured to move along the hoistway with the elevator car. The airflow duct is configured to passively direct an airflow toward the reference element to prevent accumulation of particles on the reference element.

### BACKGROUND

Exemplary embodiments pertain to the art of elevator systems, and in particular to a position reference system (PRS) of an elevator system.

Elevator systems often include a position reference systems (PRS), which is utilized to determine a position of an elevator car in the hoistway. In some elevator systems, the PRS is an optical system in which an information tape is vertically installed in the hoistway, and is read by an optical sensor mounted on the elevator car to determine the position of the elevator car in the hoistway. Hoistway environments, however, can be dusty which interferes with the function of the optical sensor.

### BRIEF DESCRIPTION

In one exemplary embodiment, a position reference system of an elevator system includes a reference element having a fixed position in a hoistway of the elevator system, and an optical sensor configured to move along the hoistway with an elevator car of the elevator system and configured to transmit a signal to the reference element to determine the position of the elevator car. An airflow duct is configured to move along the hoistway with the elevator car. The airflow duct is configured to passively direct an airflow toward the reference element to prevent accumulation of particles on the reference element.

Additionally or alternatively, in this or other embodiments, the airflow duct includes a duct body, one or more duct inlets located at one or more of a first duct end and a second duct end, and one or more duct outlets located along the duct body between the first duct end and the second duct end. The one or more duct outlets are configured to direct the airflow out of the airflow duct and toward the reference element.

Additionally or alternatively, in this or other embodiments, the one or more duct inlets are vertically downwardly facing when in an installed position on the elevator car.

Additionally or alternatively, in this or other embodiments, the one or more duct inlets are upwardly facing when in an installed position on the elevator car.

Additionally or alternatively, in this or other embodiments, the reference element is a coded tape.

Additionally or alternatively, in this or other embodiments, the airflow duct is positioned vertically above the optical sensor.

Additionally or alternatively, in this or other embodiments, the airflow duct is positioned vertically below the optical sensor.

In another exemplary embodiment, an elevator system includes a hoistway, an elevator car positioned in the hoistway and movable along the length of the hoistway, and a position reference system located in the hoistway and configured to determine a position of the elevator car in the hoistway. The position reference system includes a reference element having a fixed position in the hoistway, and an optical sensor configured to move along the hoistway with the elevator car and configured to transmit a signal to the reference element to determine the position of the elevator car. An airflow duct is configured to move along the hoistway with the elevator car. The airflow duct is configured to passively direct an airflow toward the reference element to prevent accumulation of particles on the reference element.

Additionally or alternatively, in this or other embodiments, the airflow duct includes a duct body, one or more duct inlets located at one or more of a first duct end and a second duct end, and one or more duct outlets located along the duct body between the first duct end and the second duct end. The one or more duct outlets are configured to direct the airflow out of the airflow duct and toward the reference element.

Additionally or alternatively, in this or other embodiments, the one or more duct inlets are vertically downwardly facing when in an installed position on the elevator car.

Additionally or alternatively, in this or other embodiments, the one or more duct outlets are vertically upward facing when in an installed position on the elevator car.

Additionally or alternatively, in this or other embodiments, the reference element is a coded tape.

Additionally or alternatively, in this or other embodiments, the airflow duct is positioned vertically above the optical sensor.

Additionally or alternatively, in this or other embodiments, the airflow duct is positioned vertically below the optical sensor.

In yet another exemplary embodiment, a method of operating an elevator system includes moving an elevator car along a hoistway, and determining a position of the elevator car in the hoistway via a position reference system. The position reference system includes a reference element fixed in the hoistway, and an optical sensor configured to move along the hoistway with the elevator car and configured to transmit a signal to the reference element to determine the position of the elevator car. An airflow is passively urged toward the reference element via movement of the elevator car along the hoistway to prevent accumulation of particles on the reference element.

Additionally or alternatively, in this or other embodiments, the airflow is urged toward the reference element via an airflow duct located at the elevator car and moveable along the hoistway therewith. The airflow duct includes a duct body, one or more duct inlets located at one or more of a first duct end and a second duct end, and one or more duct outlets located along the duct body between the first duct end and the second duct end, the one or more duct outlets configured to direct the airflow out of the airflow duct and toward the reference element.

Additionally or alternatively, in this or other embodiments, the elevator car is moved downwardly in the hoistway to urge the airflow toward the reference element.

Additionally or alternatively, in this or other embodiments, the one or more duct inlets are vertically downwardly facing when in an installed position on the elevator car.

Additionally or alternatively, in this or other embodiments, the reference element is a coded tape.

Additionally or alternatively, in this or other embodiments, the airflow duct is positioned vertically above the optical sensor.

### BRIEF DESCRIPTION OF THE DRAWINGS

The following descriptions should not be considered limiting in any way. With reference to the accompanying drawings, like elements are numbered alike:

FIG. 1 is a schematic illustration of an embodiment of an elevator system;

FIG. 2 is a schematic illustration of an embodiment of a position reference system of an elevator system;

FIG. 3 is an illustration of an embodiment of an airflow duct of a position reference system; and

FIG. 4 is an illustration of another embodiment of an airflow duct of a position reference system.

### DETAILED DESCRIPTION

A detailed description of one or more embodiments of the disclosed apparatus and method are presented herein by way of exemplification and not limitation with reference to the Figures.

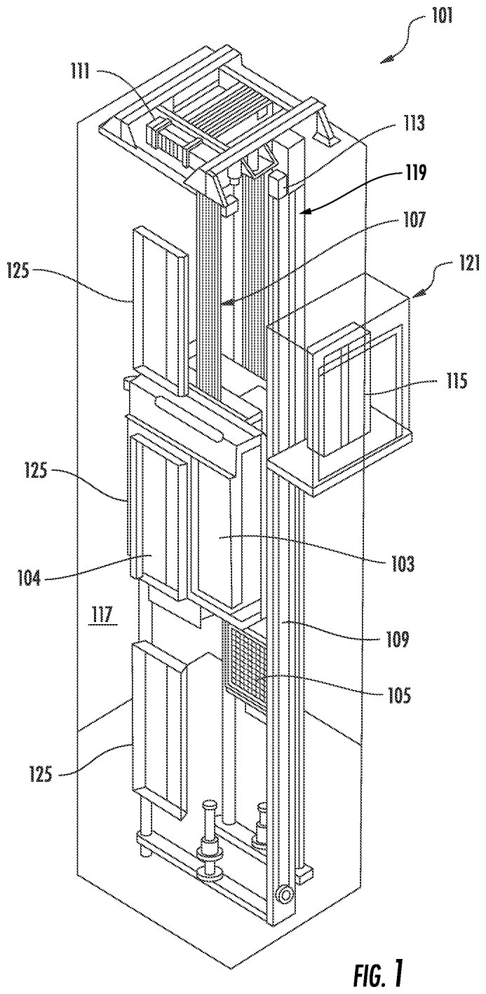

FIG. 1 is a perspective view of an elevator system 101 including an elevator car 103, a counterweight 105, a tension member 107, a guide rail 109, a machine 111, a position reference system 113, and a controller 115. The elevator car 103 and counterweight 105 are connected to each other by the tension member 107. The tension member 107 may include or be configured as, for example, ropes, steel cables, and/or coated-steel belts. The counterweight 105 is configured to balance a load of the elevator car 103 and is configured to facilitate movement of the elevator car 103 concurrently and in an opposite direction with respect to the counterweight 105 within an elevator shaft or hoistway 117 and along the guide rail 109.

The tension member 107 engages the machine 111, which is part of an overhead structure of the elevator system 101. The machine 111 is configured to control movement between the elevator car 103 and the counterweight 105. The controller 115 may be located, as shown, in a controller room 121 of the hoistway 117 and is configured to control the operation of the elevator system 101, and particularly the elevator car 103. It is to be appreciated that the controller 115 need not be in the controller room 121 but may be in the hoistway or other location in the elevator system. For example, the controller 115 may provide drive signals to the machine 111 to control the acceleration, deceleration, leveling, stopping, etc. of the elevator car 103. The controller 115 may also be configured to receive position signals from the position reference system 113 or any other desired position reference device. When moving up or down within the hoistway 117 along guide rail 109, the elevator car 103 may stop at one or more landings 125 as controlled by the controller 115. Although shown in a controller room 121, those of skill in the art will appreciate that the controller 115 can be located and/or configured in other locations or positions within the elevator system 101. In one embodiment, the controller 115 may be located remotely or in a distributed computing network (e.g., cloud computing architecture). The controller 115 may be implemented using a processor-based machine, such as a personal computer, server, distributed computing network, etc.

The machine 111 may include a motor or similar driving mechanism. In accordance with embodiments of the disclosure, the machine 111 is configured to include an electrically driven motor. The power supply for the motor may be any power source, including a power grid, which, in combination with other components, is supplied to the motor. The machine 111 may include a traction sheave that imparts force to tension member 107 to move the elevator car 103 within hoistway 117.

The elevator system 101 also includes one or more elevator doors 104. The elevator door 104 may be attached to the elevator car 103 or the elevator door 104 may be located on a landing 125 of the elevator system 101, or both. Embodiments disclosed herein may be applicable to both an elevator door 104 attached to the elevator car 103 or an elevator door 104 located on a landing 125 of the elevator system 101, or both. The elevator door 104 opens to allow passengers to enter and exit the elevator car 103.

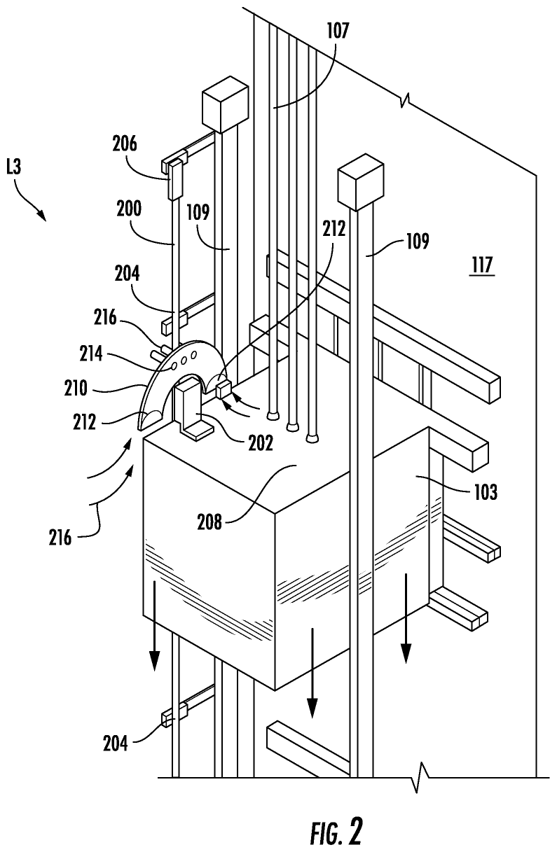

Referring now to FIG. 2, the position reference system 113 includes a reference element, such as a coded tape 200 extending along a vertical length of the hoistway 117 and fixed in the hoistway 117. The tape 200 is coded with information imprinted on or embedded in the tape 200, which when read by an optical sensor 202 indicates the vertical position of the elevator car 103 in the hoistway 117. The optical sensor 202 is disposed at the elevator car 103 and travels along the hoistway 117 with the elevator car 103. The optical sensor 202 is located at, for example, a roof 208 of the elevator car 103. In some embodiments, the tape 200 is formed from, for example, a metal or plastic material. The tape 200 is secured in the hoistway 117 via a plurality of guide clips 204 along the hoistway 117 and tension locks 206 configured to maintain a selected tension on the tape 200. The tension locks 206 are located at a vertically upper end of the tape 200 and at a vertically lower end (not shown in FIG.) of the tape 200.

The optical sensor 202 may be, for example a dual camera sensor including a light source (not shown). To determine the position, the tape 200 is illuminated by the light source, which emits, for example, one or more short infrared pulses. When the tape 200 is illuminated, the optical sensor 202 records a pattern on the tape 200 in front of optical sensor 202. The optical sensor 202 communicates a signal to the controller 115 that is indicative of the pattern read by the optical sensor 202, and the controller 115 determines the position of the elevator car 103.

Dust and other particles in the hoistway may accumulate on the tape 200, which may interfere with operation of the optical sensor 202. To alleviate this issue, an airflow duct 210 is mounted on the elevator car 103. The airflow duct 210 includes one or more duct inlets 212, and one or more duct outlets 214 to direct an airflow 216 toward the tape 200 to remove any accumulated dust or other particles from the tape 200.

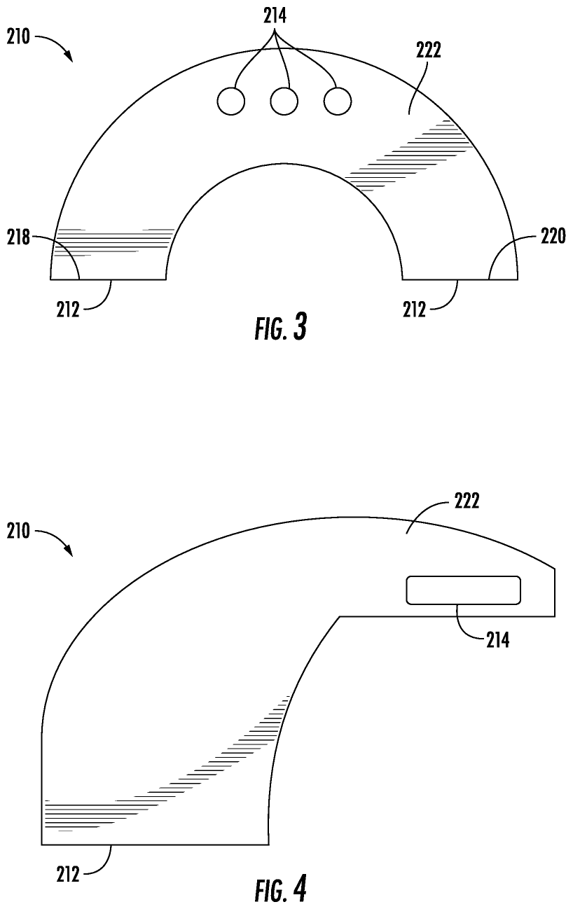

Referring now to FIG. 3, the airflow duct 210 is, for example, U-shaped and has two duct inlets 212, with a duct inlet 212 located at each of a first duct end 218 and at a second duct end 220 opposite the first duct end 218. The airflow duct 210 may be formed from a material such as a plastic, metal or composite material. The one or more duct outlets 214 are located along a duct body 222 between the first duct end 218 and the second duct end 220, and are configured and oriented to direct the airflow 216 toward the tape 200. In some embodiments, the airflow duct 210 has a constant, circular cross-section, while in other embodiments shown in FIG. 4 the cross-sectional shape and/or size of the airflow duct 210 cross-section may vary between the one or more duct inlets 212 and the one or more duct outlets 214 to provide desired properties of the airflow 216, such as airflow pressure or flow rate. For example, as shown in FIG. 4, the cross-section of the airflow duct 210 may be a converging configuration such that the cross-sectional area of the airflow duct 210 is greater at the one or more duct inlets 212 than at or near the one or more duct outlets 214.

Referring again to FIG. 3, the one or more duct outlets 214 are located, in some embodiments, at a midpoint portion of the duct body 222. In some embodiments, the one or more duct outlets 214 are three duct outlets 214 arrayed in a linear arrangement substantially horizontally across the tape 200. The duct outlets 214 may be configured to direct the airflow 216 in substantially parallel streams out of the duct outlets 214. In some embodiments the duct outlets 214 are circular, while in other embodiments, the duct outlets 214 may have other shapes, such as elliptical, quadrilateral (illustrated in FIG. 4) or oval shaped. One skilled in the art, however, will readily appreciate that the configuration described herein is merely exemplary, and that in other configurations the duct outlets 214 may have other arrangements, such as, for example, holes, slits or protruding nozzle structures, to provide selected characteristics of the airflow 216.

Referring again to FIG. 2, the airflow duct 210 is located at the elevator car 103, and travels with the elevator car 103 along the hoistway 117. In some embodiments the airflow duct 210 is positioned on the elevator car 103 such that the duct inlets 212 are located vertically below the duct outlets 214, and further may be positioned such that the duct outlets 214 are vertically above the optical sensor 202. In operation, as the elevator car 103 travels downwardly in the hoistway 117, the downward travel of the elevator car 103 urges the airflow 216 into the airflow duct 210 via the duct inlets 212, which face vertically downwardly when the airflow duct 210 is in the installed position, as shown in FIG. 2. The airflow 216 is then directed along the duct body 222 and out through the duct outlets 214 toward the tape 200. The airflow 216 directed toward the tape 200 dislodges and removes dust and other particles from the tape 200, which improves operation of the position reference system 113.

The airflow duct 210 provides cleaning of the tape 200 passively, without requiring additional power, other than that required to move the elevator car 103 along the hoistway 117. Further, orientation of the duct inlets 212 downwardly prevents the accumulation of dust in the airflow duct 210 when the elevator car 103 is stationary. Alternatively, the air duct inlet 212 may be located in an upward direction to urge airflow while the car 103 travels upwardly in the hoistway 117. To prevent accumulation of dust within the airflow duct 210, a porous filter (not illustrated) may be installed at the opening 212 to prevent accumulation of dust within the airflow duct 210.

The term “about” is intended to include the degree of error associated with measurement of the particular quantity based upon the equipment available at the time of filing the application.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the present disclosure has been described with reference to an exemplary embodiment or embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims.

What is claimed is:

1. A position reference system of an elevator system, comprising:
a reference element having a fixed position in a hoistway of the elevator system;
an optical sensor configured to move along the hoistway with an elevator car of the elevator system and configured to transmit a signal to the reference element to determine the position of the elevator car; and
an airflow duct configured to move along the hoistway with the elevator car, the airflow duct configured to passively direct an airflow toward the reference element to prevent accumulation of particles on the reference element.

2. The position reference system of claim 1, wherein the airflow duct includes:
a duct body;
one or more duct inlets located at one or more of a first duct end and a second duct end; and
one or more duct outlets located along the duct body between the first duct end and the second duct end, the one or more duct outlets configured to direct the airflow out of the airflow duct and toward the reference element.

3. The position reference system of claim 2, wherein the one or more duct inlets are vertically downwardly facing when in an installed position on the elevator car.

4. The position reference system of claim 2, wherein the one or more duct inlets are upwardly facing when in an installed position on the elevator car.

5. The position reference system of claim 1, wherein the reference element is a coded tape.

6. The position reference system of claim 1, wherein the airflow duct is positioned vertically above the optical sensor.

7. The position reference system of claim 1, wherein the airflow duct is positioned vertically below the optical sensor.

8. An elevator system, comprising:
a hoistway;
an elevator car disposed in the hoistway and movable along the length of the hoistway; and
a position reference system disposed in the hoistway and configured to determine a position of the elevator car in the hoistway, the position reference system including:
a reference element having a fixed position in the hoistway;
an optical sensor configured to move along the hoistway with the elevator car and configured to transmit a signal to the reference element to determine the position of the elevator car; and
an airflow duct configured to move along the hoistway with the elevator car, the airflow duct configured to passively direct an airflow toward the reference element to prevent accumulation of particles on the reference element.

9. The elevator system of claim 8, wherein the airflow duct includes:
a duct body;
one or more duct inlets located at one or more of a first duct end and a second duct end; and
one or more duct outlets located along the duct body between the first duct end and the second duct end, the one or more duct outlets configured to direct the airflow out of the airflow duct and toward the reference element.

10. The elevator system of claim 9, wherein the one or more duct inlets are vertically downwardly facing when in an installed position on the elevator car.

11. The elevator system of claim 9, wherein the one or more duct outlets are vertically upward facing when in an installed position on the elevator car.

12. The elevator system of claim 8, wherein the reference element is a coded tape.

13. The elevator system of claim 8, wherein the airflow duct is positioned vertically above the optical sensor.

14. The elevator system of claim 8, wherein the airflow duct is positioned vertically below the optical sensor.

15. A method of operating an elevator system, comprising:
moving an elevator car along a hoistway;
determining a position of the elevator car in the hoistway via a position reference system including:
a reference element fixed in the hoistway; and
an optical sensor configured to move along the hoistway with the elevator car and configured to transmit a signal to the reference element to determine the position of the elevator car;
passively urging an airflow toward the reference element via movement of the elevator car along the hoistway to prevent accumulation of particles on the reference element.

16. The method of claim 15, further comprising urging the airflow toward the reference element via an airflow duct located at the elevator car and moveable along the hoistway therewith, the airflow duct including:
a duct body;
one or more duct inlets located at one or more of a first duct end and a second duct end; and
one or more duct outlets located along the duct body between the first duct end and the second duct end, the one or more duct outlets configured to direct the airflow out of the airflow duct and toward the reference element.

17. The method of claim 15, further comprising moving the elevator car downwardly in the hoistway to urge the airflow toward the reference element.

18. The method of claim 17, wherein the one or more duct inlets are vertically downwardly facing when in an installed position on the elevator car.

19. The method of claim 15, wherein the reference element is a coded tape.

20. The method of claim 15, wherein the airflow duct is positioned vertically above the optical sensor.
